(19) United States
(12) Patent Application Publication
(10) Pub. No.: US 2014/0111177 A1
(43) Pub. Date: Apr. 24, 2014

(54) DC-DC CONVERTER AND METHOD FOR DRIVING SAME

(71) Applicant: Hon Hai Precision Industry Co., Ltd., New Taipei (TW)

(72) Inventors: CHUANG-WEI TSENG, New Taipei (TW); CHE-HSUN CHEN, New Taipei (TW)

(73) Assignee: HON HAI PRECISION INDUSTRY CO., LTD., New Taipei (TW)

(21) Appl. No.: 14/048,149

(22) Filed: Oct. 8, 2013

(30) Foreign Application Priority Data
Oct. 23, 2012 (CN) 2012104051412

(51) Int. Cl. H02M 3/158

(52) U.S. Cl. CPC H02M 3/1588
USPC 323/283

(57) ABSTRACT

A voltage conversion circuit includes a first signal generating unit, a signal processing unit, and a voltage converting unit. The first signal generating unit generates a first pulse width modulation (PWM) signal. The signal processing unit includes a second signal generating unit, a first logic unit, and a second logic unit. The second signal generating unit generates a second PWM signal. A frequency of the first PWM signal is different from a frequency of the second PWM signal. The first logic unit performs an AND operation to the first and second PWM signals to obtain a first control signal. The second logic unit performs a NOT operation on the first control signal to obtain a second control signal. The voltage converting unit converts a first direct current (DC) voltage into a second DC voltage under control of the first control signal and the second control signal.

### BACKGROUND

1. Technical Field

The present disclosure relates to a direct current (DC) converter/conversion circuit and a method for driving the same.

2. Description of Related Art

DC-DC conversion circuits, such as buck converters, are used to provide DC voltages to electronic components. The buck converter is usually controlled by a controlling integrated circuit (IC) and a driving IC. The controlling IC generates a first control signal and provides the first control signal to the driving IC, and the driving IC generates a second control signal according to the first control signal. The buck converter receives the first control signal and the second control signal and converts a first DC voltage into a second DC voltage under the control of the first control signal and the second control signal. A voltage value of the second DC voltage relates to a duty ratio of the first control signal and the second control signal. However, the duty ratios of both the first control signal and the second control signal generally are not less than 10% due to the limitations of fabricating abilities of the controlling IC and driving IC, that may cause a voltage value of the second DC voltage may not achieve a lower value. This means, a range of regulating the output voltage of the DC-DC converter may be limited.

Therefore, what is needed is a means that can overcome the above-described limitations.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views, and all the views are schematic.

FIG. 1 is a circuit diagram of a voltage conversion circuit according to an exemplary embodiment of the present disclosure, the voltage conversion circuit generating a first control signal.

FIG. 2 is a waveform of the first control signal generated by the voltage conversion circuit of FIG. 1.

FIG. 3 is a flowchart of a driving method of the voltage conversion circuit of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

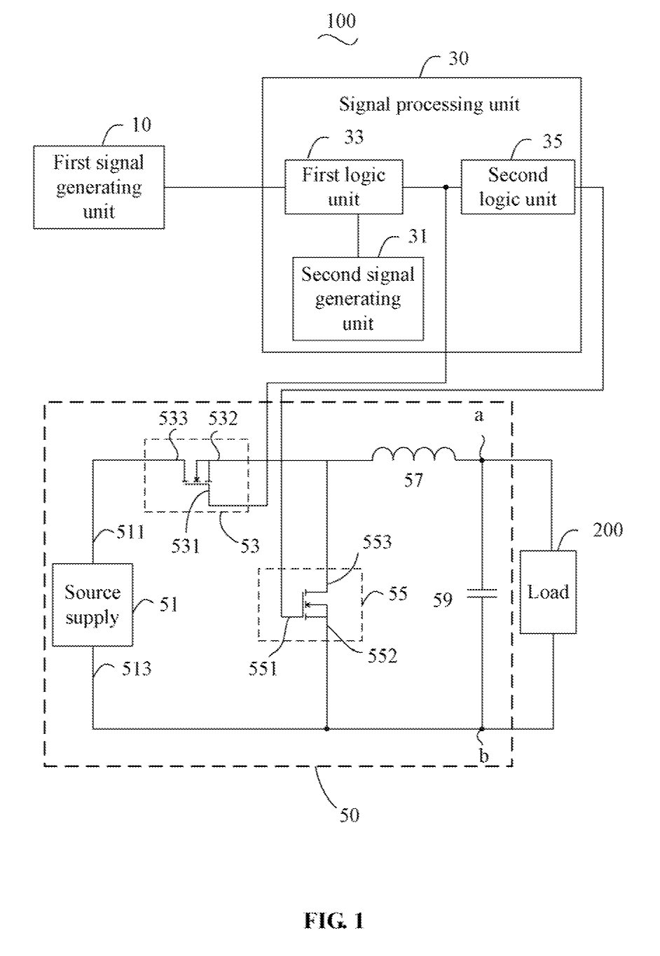

FIG. 1 shows a circuit diagram of a voltage conversion circuit 100 according to an exemplary embodiment of the present disclosure. The voltage conversion circuit 100 includes a first signal generating unit 10, a signal processing unit 30, and a voltage converting unit 50. The first signal generating unit 10 is electronically coupled to the signal processing unit 30, and the signal processing unit 30 is electronically coupled between the first signal generating unit 10 and the voltage converting unit 50.

The first signal generating unit 10 can be a controlling IC (such as a PWM IC) and is configured to provide a first PWM signal to the signal processing unit 30. In the embodiment, the first PWM signal is a square signal, which periodically changes at a first frequency, a time period D_{H}, and a duty ratio T_{H}. A duty ratio of the first PWM signal is in a range from 0 to 1 (0<D_{H}<1), and the duty ratio of the first PWM signal is regulated by the first signal generating unit 10.

The signal processing unit 30 further includes a first logic unit 33, a second logic unit 35, and a second signal generating unit 31. The signal processing unit 30 serves as a driving IC and is configured to receive the first PWM signal and a second PWM signal generated by the second signal generating unit 31, generates a first control signal in response to receiving the first PWM signal and the second PWM signal, generates a second control signal in response to receiving the first control signal, and provides the first control signal and the second control signal to the voltage converting unit 50. In the embodiment, the second signal generating unit 31 is embedded in the signal processing unit 30.

The second signal generating unit 31 is connected to the first logic unit 33, and the first logic unit 33 is connected between the second signal generating unit 31 and the second logic unit 35. The second signal generating unit 31 provides the second PWM signal to the first logic unit 33. In the embodiment, the second PWM signal is a square signal, which periodically changes at a second frequency, a time period D_{L} and a duty ratio T_{L}. A duty ratio of the second PWM signal is in a range from 0 to 1 (0<D_{L}<1), and the duty ratio of the second PWM signal is regulated by the second signal generating unit 31. In the embodiment, the second frequency is different from the first frequency. The duty ratio of the second PWM signal is substantially equal to the duty ratio of the first PWM signal. In other embodiments, the duty ratio of the second PWM signal is different from the duty ratio of the first PWM signal.

In the embodiment, the first logic unit 33 is an AND gate and is configured to generate a first control signal by performing an AND operation in response to receiving the first PWM signal and the second PWM signal. The first control signal is provided to the voltage converting unit 50 and the second logic unit 35.

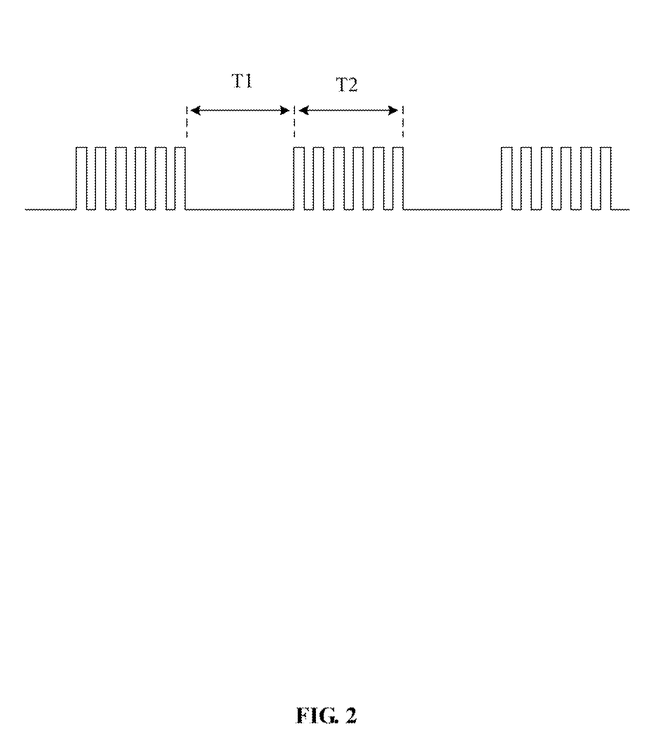

FIG. 2 is a waveform of the first control signal generated by the voltage conversion circuit 100 of FIG. 1. The first control signal is a periodic signal and includes a first sub-period T1 and a second sub-period T2 in a periodic cycle. In the first sub-period T1, the first control signal is logic zero. In the second sub-period T2, the first control signal is a square signal. It is understood that a duty ratio of the first control signal in the second sub-period T2 is less than the duty ratio of the first PWM signal, and the duty ratio of the first control signal in the second sub-period T2 is less than the duty ratio of the second PWM signal.

The second logic unit 35 may be a NOT gate and is configured to generate a second control signal by performing a NOT operation in response to receiving the first control signal. The second control signal is also provided to the voltage converting unit 50.

The voltage converting unit 50 receives the first control signal and the second control signal output from the signal processing unit 30 and converts a first DC voltage into a second DC voltage. In the embodiment, the voltage converting unit 50 is a buck converter. The voltage converting unit 50 includes a source supply 51, a first switch 53, a second switch 55, a first energy storing unit 57, a second energy storing unit 59, a first voltage output terminal “a,” and a second voltage output terminal “b.” The source supply 51 is connected between the second voltage output terminal “b” and the first switch 53. The first switch 53 is connected to the first voltage output terminal “a” via the first energy storing unit 57. The second switch 55 is connected between the second voltage output terminal “b” and a node between the first switch 53 and the first energy storing unit 57. The second energy storing unit 59 is connected between the first voltage output terminal “a” and the second voltage output terminal “b”.

The source supply 51 is configured to generate the first DC voltage. The source supply 51 includes a first output terminal 511 and a second output terminal 513 and outputs the first DC voltage via the first output terminal 511 and the second output terminal 513.

The first switch 53 receives the first control signal and is switched on or off under the control of the first control signal. The first switch 53 includes a control terminal 531, a first switching terminal 532, and a second switching terminal 533. The control terminal 531 receives the first control signal and controls the first switching terminal 532 and the second switching terminal 533 to switch the first switch 53 on or off. The second switching terminal 533 is connected to the first output terminal 511, and the first switching terminal 532 is connected to the first energy storing unit 57. In the embodiment, the first switch 53 is an n-channel metal-oxide semiconductor field effect transistor (NMOSFET), the control terminal 531 is a gate of the NMOSFET, the first switching terminal 532 is a source of the NMOSFET, and the second switching terminal 533 is a drain of the NMOSFET.

The second switch 55 receives the second control signal and is switched on or off under the control of the second control signal. In the embodiment, the second switch 55 and the first switch 53 are switched on alternately. The second switch 55 includes a control terminal 551, a first switching terminal 552, and a second switching terminal 553. The control terminal 551 receives the second control signal and controls the first switching terminal 552 and the second switching terminal 553 to switch the second switch 55 on or off. The first switching terminal 552 is connected to the second voltage output terminal “b.” The second switching terminal 553 is connected to a node formed between the first switch 53 and the first energy storing unit 57. In the embodiment, the second switch 55 is an NMOSFET. The control terminal 551 is a gate of the NMOSFET, the first switching terminal 552 is a source of the NOMFET, and the second switching terminal 553 is a drain of the NMOSFET.

The first energy storing unit 57 stores energy by being charged by the first DC voltage when the first switch 53 is switched on and discharges the energy to the second energy storing unit 57 when the first switch 53 is switched off. In the embodiment, the first energy storing unit 57 is an inductor.

The second energy storing unit 59 stores energy by being charged by the first energy storing unit 57 and discharges the energy to the load 200. In this process, the energy stored in the second energy storing unit 59 is converted into the second DC voltage. In the embodiment, the second energy storing unit 59 is a capacitor.

In the present disclosure, the first logic unit 33 performs an AND operation in response to receiving the first PWM signal and the second PWM signal, such that a duty ratio of the first control signal is less than both the duty ratio of the first PWM signal and the duty ratio of the second PWM signal. Thus, the voltage converting unit 50 is capable of outputting the second DC voltage having a lower voltage value, even though the duty ratio of the first PWM signal is not less than a predetermined value, such as 10%.

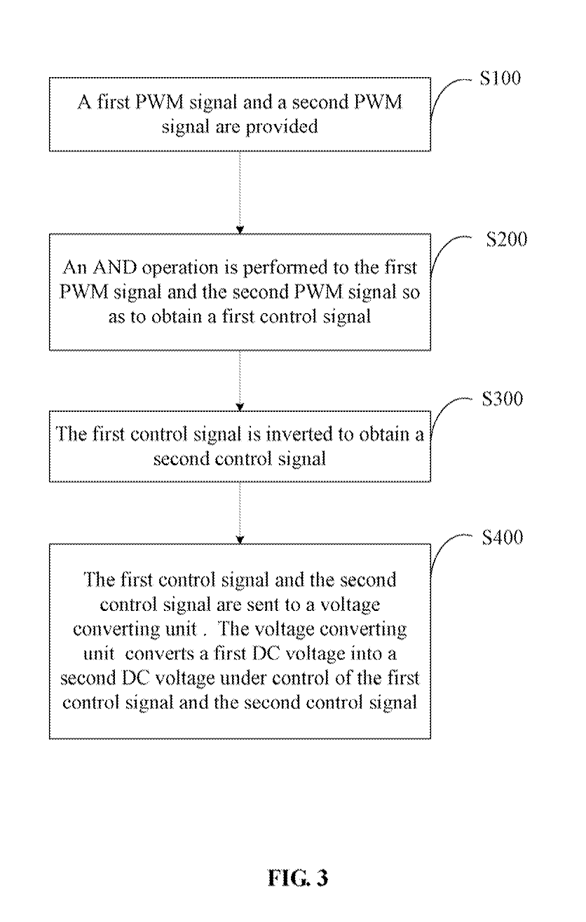

FIG. 3 shows a flowchart of a driving method of the voltage conversion circuit 100 according to one embodiment of the present disclosure. Depending on the embodiment, additional steps may be added, others removed, and ordering of the steps may be changed.

In step S100, a first PWM signal and a second PWM signal are provided.

In step S200, an AND operation is performed to the first PWM signal and the second PWM signal so as to obtain a first control signal.

In step S300, the first control signal is inverted to obtain a second control signal.

In step S400, the first control signal and the second control signal are sent to the voltage converting unit 50. The voltage converting unit 50 converts a first DC voltage into a second DC voltage under the control of the first control signal and the second control signal.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An DC-DC converter, comprising:
a first signal generating unit generating a first pulse width modulation (PWM) signal;
a signal processing unit comprising a second signal generating unit, a first logic unit and a second logic unit, the second signal generating unit generating a second PWM signal, the first logic unit performing an AND operation to the first PWM signal and the second PWM signal so as to obtain a first control signal, the first control signal being a periodic signal, the first control signal including a first sub-period and a second sub-period in a period cycle, in the first sub-period, the first control signal being logic zero and in the second sub-period the first control signal being a square signal, a duty ratio of the square signal being less than a duty ratio of the first PWM signal and a duty ratio of the second PWM signal, the second logic unit generating a second control signal by inverting the first control signal; and
a voltage converting unit converting a first direct current (DC) voltage into a second DC voltage under control of the first control signal and the second control signal.

2. The DC-DC converter according to claim 1, wherein the first logic unit is an AND gate and the second logic unit is a NOT gate.

3. The DC-DC converter according to claim 1, wherein a frequency of the first PWM signal is different from a frequency of the second PWM signal.

4. The DC-DC converter according to claim 1, wherein a duty ratio of the first PWM signal is equal to a duty ratio of the second PWM signal.

5. The DC-DC converter according to claim 1, wherein a duty ratio of the first PWM signal is different from a duty ratio of the second PWM signal.

6. The DC-DC converter according to claim 1, wherein the voltage converting unit comprises:
a source supply generating the first DC voltage;
a first switch switching on or switching off under control of the first control signal;
a second switch alternately switching with the first switch under control of the second control signal;
a first energy storing unit storing energy by charging of the first DC voltage when the first switch is switched on and the second switch is switched off and discharging when the first switch is switched off and the second switch is switched on; and
a second energy storing unit receiving energy discharged by the first energy storing unit and converting the first DC voltage into a second DC voltage;
a first voltage output terminal; and
a second voltage output terminal outputting the second DC voltage corresponding with the first voltage output terminal.

7. The DC-DC converter according to claim 7, wherein the source supply is connected between the second voltage output terminal and the first switch; the first switch is connected the first energy storing unit to the first voltage output terminal; the second switch is connected between the second voltage output terminal and a node formed between the first switch and the first energy storing unit; and the second energy is connected between the first voltage output terminal and the second voltage output terminal.

8. The DC-DC converter according to claim 7, wherein each of the first switch and the second switch comprises a first control terminal, a first switching terminal and a second switching terminal; the control terminal of the first switch receives the first control signal and is switched on or is switched off the first switch, the control terminal of the second switch receives the second control signal and is switched on or is switched off the second switch; the first switching terminal of the first switch is connected to the first energy storing unit and the second switching terminal of the first switch is connected to a first output terminal of the source supply; and the first switching terminal of the second switch is connected to the second voltage output terminal and the second switching terminal of the second switch is connected to a node formed between the first switch and the first energy storing unit.

9. The DC-DC converter according to claim 8, wherein the first switch and the second switch are a same type transistor.

10. The DC-DC converter according to claim 9, wherein the first switch and the second switch are n-channel metal-oxide semiconductor field effect transistors (NMOSFET), the control terminal is a gate of the NMOSFET, the first switching terminal is a source of the NMOSFET and the second switching terminal is a drain of the NMOSFET.

11. The DC-DC converter according to claim 6, wherein the first energy storing unit is an inductor.

12. The DC-DC converter according to claim 6, wherein the second energy storing unit is a capacitor.

13. A DC-DC converter, comprising:
a first signal generating unit generating a first pulse width modulation (PWM) signal, the first PWM signal being a square signal;
a signal processing unit comprising a second signal generating unit, a first logic unit and a second logic unit, the second signal generating unit generating a second PWM signal, the second PWM signal being a square signal and a frequency of the second PWM signal being different from a frequency of the first PWM signal, the first logic unit performing an AND operation to the first PWM signal and the second PWM signal to obtain a first control signal, the second logic unit generating a second control signal by inverting the first control signal; and
a voltage converting unit comprises a source supply, a first switch, a second switch, a first energy storing unit, a second energy unit, a first voltage output terminal and a second voltage output terminal, the source supply generating a first direct current (DC) voltage, the first switch switching on or switching off under control of the first control signal, the second switch alternately switching on with the first switch; when the first switch switching on and the second switch switching off, the first energy storing unit storing energy by charging of the first DC voltage, and discharging to the second energy storing unit when the first switch switching off and the second switch switching on; the second energy storing unit receiving energy discharged by the first energy storing unit and converting the first DC voltage into a second DC voltage.

14. The DC-DC converter according to claim 13, wherein the first logic unit is an AND gate, the second logic unit is a NOT gate.

15. The DC-DC converter according to claim 13, wherein a duty ratio of the first PWM signal is equal to a duty ratio of the second PWM signal.

16. The DC-DC converter according to claim 13, wherein a duty ratio of the first PWM signal is different from a duty ratio of the second PWM signal.

17. The DC-DC converter according to claim 13, wherein the first switch and the second switch are n-channel metal-oxide semiconductor field effect transistors (NMOSFET).

18. The DC-DC converter according to claim 13, wherein the first energy storing unit is an inductor.

19. The DC-DC converter according to claim 13, wherein the second energy storing unit is a capacitor.

20. A method for driving a DC-DC converter, comprising:
providing a first PWM signal and a second PWM signal, the first PWM signal and the second PWM signal being square signals, a frequency of the first PWM signal being different from a frequency of the second PWM signal;
performing an AND operation to the first PWM signal and the second PWM signal so as to obtain a first control signal;
inverting the first control signal to obtain a second control signal; and
providing the first control signal and the second control signal to a voltage converting unit, the voltage converting unit converting a first DC voltage to a second DC voltage under control of the first control signal and the second control signal.
